(19) United States
(12) Patent Application Publication
(10) Pub. No.: US 2009/0207925 A1
(43) Pub. Date: Aug. 20, 2009

(54) Wireless communication system, OFDM communication apparatus and method thereof

(75) Inventor: Tai-Cheng Liu, Kaohsiung City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 12/031,831

(22) Filed: Feb. 15, 2008

(51) Int. Cl. H04L 27/28

(52) U.S. Cl. 375/260

(57) ABSTRACT

A wireless communication system adapted for the IEEE 802.11 or IEEE 802.16 standard comprises a radio frequency (RF) receiver, an analog-to-digital converter (ADC), and an OFDM communication apparatus. The RF receiver receives a radio signal. The ADC converts the radio signal to a digital signal. The OFDM communication apparatus comprises a digital filter, a notch filter, a fast Fourier transform (FFT) processor, and a detection element. The digital filter processes the digital signal to generate a processed digital signal. The notch filter filters out interference of the processed signal to generate a notched signal according to a filter band. The FFT processor performs an FFT process on the notched signal to generate an FFT signal according to the processed digital signal. The detection element generates the filter band of the notch filter according to the FFT signal.

### CROSS-REFERENCES TO RELATED APPLICATIONS

Not applicable.

### BACKGROUND OF THE INVENTION

1. Field of the Invention

The present invention relates to a wireless communication system, an orthogonal frequency division multiplexing (OFDM) communication apparatus and a method thereof for handle interference of a digital signal.

2. Descriptions of the Related Art

Communication systems often need to handle interference, as it always hinders the performance of the communication system. There are many types of interference. One type of interference comes from signals within a similar frequency band transmitted by other signal sources. This is the so-called co-channel interference.

As a commonly used communication technique, OFDM divides an available bandwidth into sub-carriers that are orthogonal to one another in the frequency domain. Each sub-carrier carries a part of data. If the sub-carriers cannot reach a receiver at an appropriate time due to the time delay, the data fails to reach the receiver. This multi-path effect is called intersymbol interference, resulting from some of the sub-carriers mixing together because of simultaneous arrival. As a result, the receiver cannot clearly separate them.

In the time domain of the OFDM communication system, the receiver of the OFDM communication system can perform synchronization with a transmitter of the same. There are many steps to the synchronization, such as packet detection, frequency offset estimation, sample timing offset estimation, symbol boundary timing decision, etc.. When a symbol boundary timing decision is affected by noise and/or interference, a wrong decision results. Under strong noise and/or interference conditions, the spatial statistical characterization of noise and/or interference is degraded to the point that the OFDM communication system no longer optimally restores data. Optimal interference cancellation no longer occurs and in effect, the OFDM communication system loses track of the spatial characteristics of the noise and/or interference and can no longer properly account for them. Accordingly, the synchronization is not accurate and the orthogonality of the sub-carriers of the communication system is destroyed since the symbol boundary is incorrect, therefore, the data is unable to be restored.

Because interference can be both synchronous and asynchronous, this complication can greatly reduce the efficiency of the communication system, especially for adjusting a power level of a signal transmitted in the OFDM communication system. Thus, a need exists for reducing interference within the communication system and adjusting the power level of a signal transmitted in the communication system to maintain the orthogonality of the sub-carriers of the communication system.

### SUMMARY OF THE INVENTION

One objective of this invention is to provide an OFDM communication apparatus which comprises a digital filter, a notch filter, a fast Fourier transform (FFT) processor, and a detection element. The digital filter processes a digital signal to generate a processed digital signal. The notch filter filters out interference of the processed signal to generate a notched signal according to a filter band. The FFT processor performs an FFT process on the notched signal to generate an FFT signal according to the processed digital signal. The detection element generates the filter band of the notch filter according to the FFT signal.

Another objective of this invention is to provide an OFDM communication method which comprises the following steps: processing a digital signal to generate a processed digital signal; filtering out interference of the processed signal to generate a notched signal according to a filter band; performing an FFT process on the notched signal to generate an FFT signal according to the processed digital signal; and generating the filter band of the notch filter according to the FFT signal.

Another objective of this invention is to provide an OFDM communication apparatus which comprises means for processing a digital signal to generate a processed digital signal; means for filtering out the processed signal to generate a notched signal according to a filter band; means for performing an FFT process on the notched signal to generate an FFT signal according to the processed digital signal; and means for generating the filter band of the notch filter according to the FFT signal.

Another objective of this invention is to provide a wireless communication system adapted for the IEEE 802.11 or IEEE 802.16 standard. The wireless communication system comprises a radio frequency (RF) receiver, an analog-to-digital converter (ADC), and an OFDM communication apparatus. The RF receiver receives a radio signal. The ADC converts the radio signal to a digital signal. The OFDM communication apparatus filters out interference of the digital signal to generate a filtered signal, performs an FFT process on the filtered signal to generate an FFT signal, and generating the filter band according to the FFT signal.

Another objective of this invention is to provide a communication method under the IEEE 802.11 or IEEE 802.16 standard. The communication method comprises the following steps: receiving a radio signal; converting the radio signal to a digital signal; filtering out interference of the digital signal to generate a filtered signal according to a filter band; performing an FFT process on the filtered signal to generate an FFT signal, and generating the filter band according to the FFT signal.

The present invention can filter interference and adjust a power level of a digital signal generated from a radio signal so that data carried on the radio signal can be restored accurately.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating a first embodiment of the present invention;

FIG. 2 is a block diagram illustrating a second embodiment of the present invention;

FIG. 3 is a flow chart illustrating a third embodiment of the present invention;

FIG. 4 is a flow chart illustrating that removing the interference of received packets in frequency domain of the third embodiment; and

FIG. 5 is a flow chart illustrating a fourth embodiment of the present invention.

### DESCRIPTION OF THE PREFERRED EMBODIMENT

In this specification, the term “according to” is defined as “replying to” or “reacting to.” For example, “according to a signal” means “replying to a signal” or “reacting to a signal” without necessity of direct signal reception.

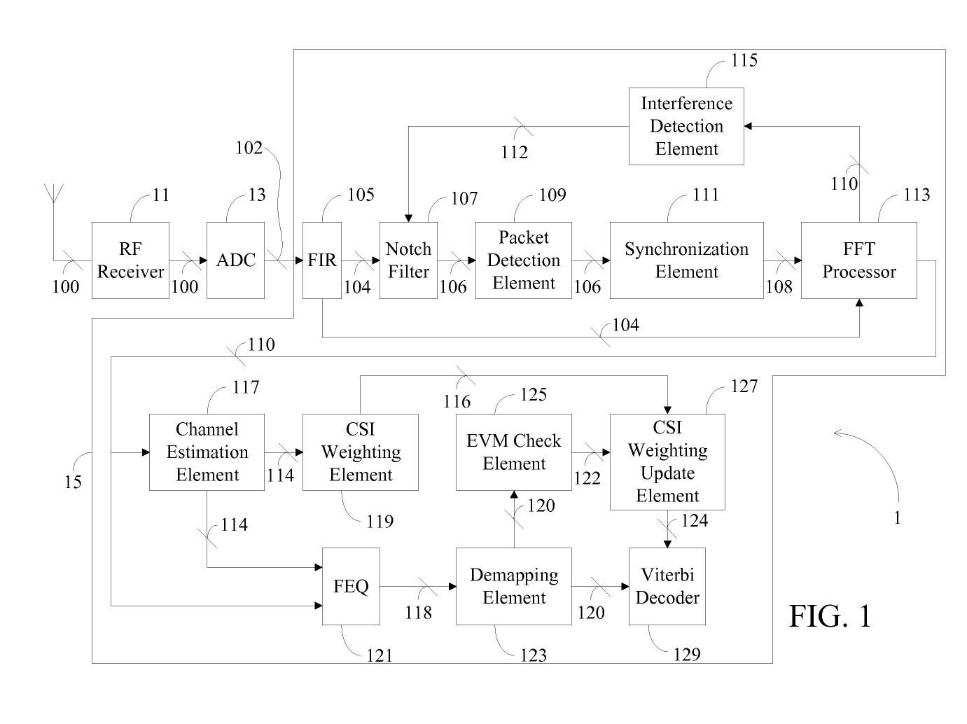

As shown in FIG. 1, a first embodiment of the present invention is a wireless communication system 1 which is adapted for OFDM communication technique, such as an IEEE 802.11 standard or an IEEE 802.16 standard. The wireless communication system 1 comprises an RF receiver 11, an ADC 13, and an OFDM communication apparatus 15. The OFDM communication apparatus 15 comprises a finite impulse response (FIR) filter 105, a notch filter 107, a packet detection element 109, a synchronization element 111, an FFT processor 113, an interference detection element 115, a channel estimation element 117, a channel state information (CSI) weighting element 119, a frequency domain equalizer (FEQ) 121, a demapping element 123, an error vector magnitude (EVM) check element 125, a CSI weighting update element 127, and a Viterbi decoder 129.

When the OFDM communication system 1 is in an idle time, the OFDM communication system 1 may start to find the bandwidth of interference. The idle time means that the OFDM communication system 1 is in a period of receiving no packet. The RF receiver 101 captures a radio signal 100, an OFDM symbol, which is a time-domain analog signal. The ADC 103 converts the radio signal 100 to a digital signal 102. The FIR filter 105 filters the digital signal 102 to generate a filtered digital signal 104. More particularly, the filtered digital signal 104 is the base band of the digital signal 102. The notch filter 107 initially filters out the interference of the filtered digital signal 104 to generate a notched signal 106 according to a predetermined filter band of the notch filter 107. The packet detection element 109 detects whether the notched signal 106 carries packets. In the idle time, there is no packet detected. The synchronization element 111 synchronizes the notched signal 106 to generate a synchronal signal 108. There are many actions in the synchronization, such as frequency offset estimation, sample timing offset estimation, symbol boundary timing decision, etc.. The FFT processor 113 then performs an FFT process based on the synchronal signal 108 and the filtered digital signal 104, generating an FFT signal 110 which is a frequency-domain digital signal.

Furthermore, the interference detection element 115 analyzes the FFT signal 110 to find the bandwidth of the interference, and generates an adjustment signal 112. More particularly, the interference detection element 115 compares the power of each sub-carriers of the FFT signal 110 with a predetermined threshold. If the power is larger than the predetermined threshold, the corresponding sub-carriers are determined having interference. Based on the comparison, the interference detection element 115 may locate the bandwidth of the interference which is recorded in the adjustment signal 112. The filter band of the notch filter 107 is now adjusted according to the adjustment signal 112. Therefore, when the OFDM communication system 1 starts to receive packets, the notch filter 107 can filter out the interference more accurately in time domain according to the adjustment signal 112.

When the OFDM communication system 1 starts to receive packets, the packet detection element 109 detects that there are packets coming. The OFDM communication system 1 is now able to further remove the interference in frequency domain. After the FFT signal 110 is generated, the channel estimation element 117 finds abnormal sub-carriers of the FFT signal 110, and generates a CSI adjustment signal 114. More particularly, the channel estimation element 117 retrieves the long preamble of the FFT signal 110 to compare each sub-carrier with other sub-carriers to determine if the difference between the sub-carrier and others is larger than another threshold. If yes, the EVM of the sub-carrier is treated bad. The CSI adjustment signal 114 carries the information of bad sub-carriers. The CSI weighting element 119 adjusts the CSI weighting factors of the bad sub-carriers and generates a first CSI adjustment signal 116 according to the CSI adjustment signal 114. The FEQ 121 equalizes the FFT signal 110 in response to the CSI adjustment signal 114 to generate an equalized FFT signal 118. The demapping element 123 receives and demaps the equalized FFT signal 118 to generate a demapped FFT signal 120. The EVM check element 125 finds abnormal EVMs of the sub-carriers of the FFT signal 110, and generates a second CSI adjustment signal 122. The CSI weighting update element 127 updates the CSI weight factors of all the sub-carriers according to the second CSI adjustment signal 122 and the first CSI adjustment signal 116. Finally, the Viterbi decoder 129 decodes the demapped FFT signal 120 according to an updated weight factor 124 which is retrieved from the CSI weighting update element 127. Therefore, the OFDM communication system 1 can remove the interference more accurately in frequency domain.

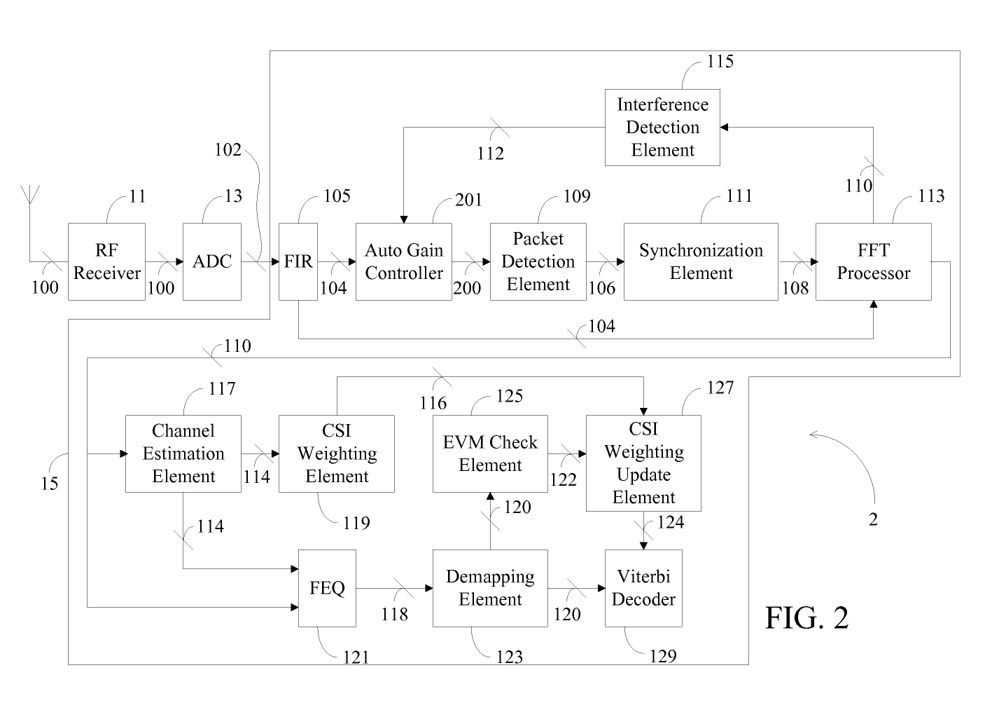

A second embodiment of the present invention is another wireless communication system 2 as illustrated in FIG. 2. In contrast with the first embodiment, the notch filter 107 is replaced by an auto gain controller 201. The auto gain controller 201 adjusts the power level of the filtered digital signal 104 to generate a processed signal 200 according to the adjusting signal 112. In other words, the auto gain controller 201 adjusts its gain according to the adjusting signal 112 in order to adjust the power level of the filtered digital signal 104. According to such an arrangement, the auto gain controller 201 is able to adjust the power level in a short time. The rest elements of wireless communication system 2 are similar to those of the wireless communication system 1.

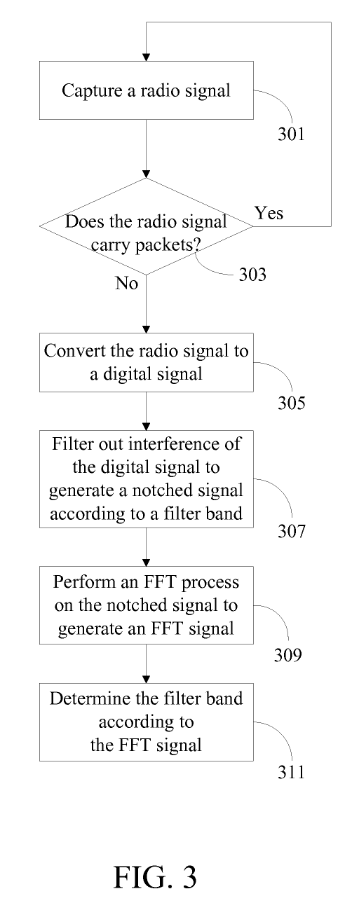

A third embodiment of the present invention is a communication method under OFDM communication technique, such as IEEE 802.11 standard or IEEE 802.16 standard. More specifically, the third embodiment may be applied to the first embodiment. That is, the third embodiment may be performed by a system like the first embodiment. FIG. 3 shows how to filter out interference in time domain in an idle time. In step 301, a receiver, such as the receiver 101, captures a radio signal, i.e., an OFDM symbol. In step 303, a detection element, such as the packet detection element 109, determines whether the radio signal carries packets. If yes, the method returns to step 301. If no, step 305 is executed in which a converter, such as the ADC 103, converts the radio signal to a digital signal. In step 307, a notch filter, such as the notch filter 107, filters out interference of the digital signal to generate a notched signal according to a filter band of the notch filter. In step 309, a processor, such as the FFT processor 113, performs an FFT process on the notched signal to generate an FFT signal. In step 311, an interference detection element, such as the interference detection element 115, determines the filter band of the notch filter 107 according to the FFT signal. The filter band of the notch filter is now adjusted. Therefore, when the OFDM communication system starts to receive packets, the notch filter can filter out the interference more accurately in time domain.

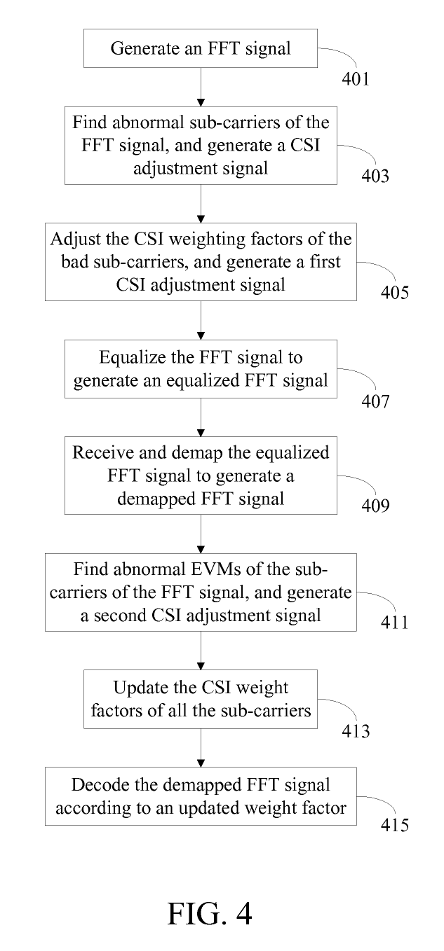

When the OFDM communication system starts to receive packets, the OFDM communication system is now able to further remove the interference in frequency domain. FIG. 4 shows a flow chart for this.. In step 401, an FFT signal is generated, wherein the generation of the FFT signal follows the steps in FIG. 3. In step 403, a channel estimation element, such as the channel estimation element 117, finds abnormal sub-carriers of the FFT signal, and generates a CSI adjustment signal. More particularly, the channel estimation element retrieves the long preamble of the FFT signal to compare each sub-carrier with other sub-carriers to determine if the difference between the sub-carrier and others is larger than another threshold. If yes, the EVM of the sub-carrier is treated bad. The CSI adjustment signal carries the information of bad sub-carriers. In step 405, a CSI weighting element, such as the CSI weighting element 119, adjusts the CSI weighting factors of the bad sub-carriers and generates a first CSI adjustment signal according to the CSI adjustment signal. In step 407, a FEQ, such as the FEQ 121, equalizes the FFT signal in response to the CSI adjustment signal to generate an equalized FFT signal.

In step 409, a demapping element, such as the demapping element 123, receives and demaps the equalized FFT signal to generate a demapped FFT signal. In step 411, an EVM check element, such as the EVM check element 125, finds abnormal EVMs of the sub-carriers of the FFT signal, and generates a second CSI adjustment signal. In step 413, a CSI weighting update element, such as the CSI weighting update element 127, updates the CSI weight factors of all the sub-carriers according to the second CSI adjustment signal and the first CSI adjustment signal. Finally, in the step 415, a decoder, such as the Viterbi decoder 129, decodes the demapped FFT signal according to an updated weight factor which is retrieved from the CSI weighting update element. Therefore, the OFDM communication system can remove the interference more accurately in frequency domain.

In addition to the steps shown in FIG. 3 and FIG. 4, the third embodiment is capable of performing all the operations or functions recited in the first embodiment. Those skilled in the art can straightforwardly realize how the third embodiment performs these operations and functions based on the above descriptions of the first embodiment. Therefore, the descriptions for these operations and functions are redundant and not repeated herein.

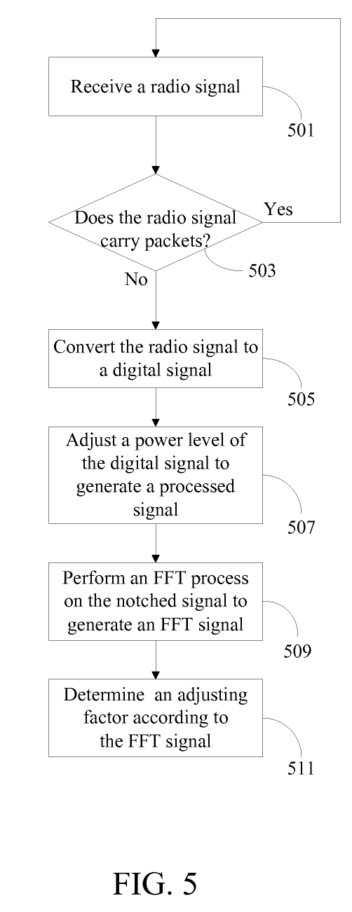

A fourth embodiment of the present invention is a communication method under OFDM communication technique, such as an IEEE 802.11 standard or an IEEE 802.16 standard. More particularly, the forth embodiment may be applied to the second embodiment. That is, the forth embodiment may be performed by a system like the second embodiment. As shown in FIG. 5, the forth embodiment comprises the following steps. In step 501, a receiver, such as the receiver 101, receives a radio signal. In step 503, a detection element, such as the packet detection element 109, determines whether the radio signal carries packets. If yes, the method returns to step 501. If no, step 505 is executed, in which a converter, such as the ADC 103, converts the radio signal to a digital signal. In step 507, a controller, such as the auto gain controller 201, adjusts a power level of the digital signal to generate a processed signal. In step 509, a processor, such as the FFT processor 113, performs an FFT process on the processed signal to generate an FFT signal. In step 511, an adjusting factor of the auto gain controller 201 is determined according to the FFT signal. According to such an arrangement, the controller is able to adjust the power level in a short time. The rest steps of the fourth embodiment are similar to those of the third embodiment.

In addition to the steps shown in FIG. 5, the fourth embodiment is capable of performing all the operations or functions recited in the second embodiment. Those skilled in the art can straightforwardly realize how the fourth embodiment performs these operations and functions based on the above descriptions of the second embodiment. Therefore, the descriptions for these operations and functions are redundant and not repeated herein.

Accordingly, the present invention can filter inference of the radio signal of an OFDM communication system, while also maintaining the orthogonality of the sub-carriers of the OFDM communication system in time domain In other words, the bandwidth of the interference of the radio signal will be notched so that the interference within the OFDM communication system will be reduced. Furthermore, the present invention can remove inference of the radio signal in frequency domain. The data carried on the radio signal will be decoded accurately thereby.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An orthogonal frequency division multiplexing (OFDM) communication apparatus, comprising:
a digital filter for processing a digital signal to generate a processed digital signal;
a notch filter for filtering out interference of the processed digital signal to generate a notched signal according to a filter band;
a fast Fourier transform (FFT) processor for performing an FFT process on the notched signal to generate an FFT signal according to the processed digital signal; and
a detection element for generating the filter band of the notch filter according to the FFT signal.

2. The OFDM communication apparatus as claimed in claim 1, wherein the digital filter is a finite impulse response (FIR) filter.

3. The OFDM communication apparatus as claimed in claim 1, wherein the filter band of the notch filter is determined in an idle time.

4. The OFDM communication apparatus as claimed in claim 3, wherein the idle time is a period of receiving no packet.

5. The OFDM communication apparatus as claimed in claim 1, further comprising a decoder for decoding data according to the FFT signal generated after the FFT processor performs the FFT process, wherein a weighting factor for decoding the data is determined before the decoder receives the data.

6. The OFDM communication apparatus as claimed in claim 5, wherein the weighting factor is a channel state information (CSI).

7. The OFDM communication apparatus as claimed in claim 5, wherein the decoder is a Viterbi decoder.

8. An OFDM communication method, comprising the steps of:
processing a digital signal to generate a processed digital signal;
filtering out interference of the processed digital signal to generate a notched signal according to a filter band;
performing an FFT process on the notched signal to generate an FFT signal according to the processed digital signal; and
generating the filter band of the notch filter according to the FFT signal.

9. The OFDM communication method as claimed in claim 8, wherein the processing step is executed by an FIR filter.

10. The OFDM communication method as claimed in claim 8, wherein the filter band used in the filtering step is determined in an idle time.

11. The OFDM communication method as claimed in claim 10, wherein the idle time is a period of receiving no packet.

12. The OFDM communication method as claimed in claim 8, further comprising the step of decoding data according to an FFT signal generated after the performing step, wherein a weighting factor for decoding the data is determined before the decoding step.

13. The OFDM communication method as claimed in claim 12, wherein the weighting factor is a channel state information (CSI).

14. The OFDM communication method as claimed in claim 12, wherein the decoding step is executed by a Viterbi decoder.

15. An OFDM communication apparatus, comprising:
means for processing a digital signal to generate a processed digital signal;
means for filtering out the processed digital signal to generate a notched signal according to a filter band;
means for performing an FFT process on the notched signal to generate an FFT signal according to the processed digital signal; and
means for generating the filter band of the notch filter according to the FFT signal.

16. A wireless communication system, comprising:
a radio frequency (RF) receiver for receiving a radio signal;
an analog-to-digital converter (ADC) for converting the radio signal to a digital signal; and
an OFDM communication apparatus for filtering out interference of the digital signal to generate a filtered signal according to a filter band, performing an FFT process on the filtered signal to generate an FFT signal, and generating the filter band according to the FFT signal.

17. The wireless communication system as claimed in claim 16, wherein the wireless communication system is adapted for one of the IEEE 802.11 standard and the IEEE 802.16 standard.

18. A communication method, comprising the steps of:
receiving a radio signal;
converting the radio signal to a digital signal;
filtering out interference of the digital signal to generate a filtered signal according to a filter band;
performing an FFT process on the filtered signal to generate an FFT signal; and
generating the filter band according to the FFT signal.

19. The communication method as claimed in claim 18, wherein the communication method is used in one of the IEEE 802.11 standard and the IEEE 802.16 standard.
